(19) United States
(12) Patent Application Publication
(10) Pub. No.: US 2025/0083169 A1
(43) Pub. Date: Mar. 13, 2025

(54) AUTOMATIC EXTRACTION DEVICE AND CONNECTOR FOR PERFUME DECANTING

(71) Applicant: Yanjun Tian, Dongguan City (CN)

(72) Inventor: Yanjun Tian, Dongguan City (CN)

(21) Appl. No.: 18/552,440

(22) PCT Filed: Aug. 14, 2023
(86) PCT No.: PCT/CN2023/112907

§ 371 Date: Sep. 26, 2023

(30) Foreign Application Priority Data
Aug. 15, 2022 (CN) 202210973346.4
Nov. 16, 2022 (CN) 202223048915.9

(51) Int. Cl. B05B 11/10; A45D 34/02

(52) U.S. Cl. CPC B05B 11/109; B05B 11/1052; A45D 34/02

(57) ABSTRACT

An automatic extraction device and connector for perfume decanting are disclosed. In this automatic extraction device, the front end of the piston cylinder is formed with a nozzle. The piston extends into the cavity of the piston cylinder. A press piece is mounted at the rear end of the piston rod and extends to the outside of the piston cylinder. A liner is fixedly provided inside the piston cylinder. The front end of the piston rod passes through the liner and is fixedly connected with the piston. The space between the liner and the nozzle inside the piston cylinder forms the compression space of the piston. The thrust produced by the compression spring on the piston rod drives the piston to have a tendency to move away from the nozzle.

### TECHNICAL FIELD

The invention pertains to the technical field of perfume decanting products, specifically an automatic extraction device and connector for perfume decanting.

### BACKGROUND ART

Most perfumes sold in the market are currently filled in glass bottles. Due to their relatively large size, they are not convenient for carrying around. As a result, there has been the introduction of perfume refill bottles in the market. As seen in the Chinese patent number 200720051806.9, an invention discloses a “portable rechargeable spray bottle”. Another invention under Chinese patent number 201120334344.8 reveals a “replaceable cyclic decanting device and a container equipped with this device”. Both patents provide a type of product for perfume refill bottles. These refill bottles are roughly the size of a standard lipstick, making them portable and particularly suitable for women.

Given that most commercially sold perfumes are designed to prevent evaporation, the bottle openings typically feature a press-pump nozzle. By pressing the nozzle, the pump is activated to expel the perfume from the bottle, which is then atomized and sprayed out. Due to the high cost of perfume and to guard against counterfeit products, typical perfume bottles have their spray heads integrated into the bottle design, making them inseparable. This design makes it impossible to pour the perfume directly into a refill bottle. To address this, current perfume refill bottles have incorporated a one-way valve decanting design. In use, one would remove the nozzle from the perfume bottle, press the nozzle directly against the refill bottle's inlet, and repeatedly press the perfume bottle, causing it to continuously spray and transfer the perfume into the refill bottle. This method essentially replaces the decanting port of the perfume refill bottle with the nozzle of the perfume bottle, transferring the perfume from the original bottle to the refill bottle.

The inventor previously proposed a “connector for perfume bottle decanting”, with patent document number CN213414374U. This connector facilitates perfume decanting and ensures compatibility between refill bottles and various perfume bottles. However, this method still requires users to repeatedly press the perfume nozzle, often multiple times, and the amount of perfume transferred to the refill bottle is limited. For the primary female users of perfume refill bottles, this method is time-consuming, strenuous, and inconvenient.

Addressing the above issues, the inventor introduced a technical solution titled “Injection Device for Perfume Refill Bottle”, patent document number CN215667074U, and later proposed an invention patent application titled “Filling Machine for Perfume Refill Bottle”, patent document number CN114408239A. Both technical solutions use a pump or electric drive to transfer perfume from the original bottle directly into the refill bottle. However, due to the use of electric drives, the size of these devices is relatively large, and they require an independent power source or external connection, making them less portable.

In light of the various problems described above, the inventor, after further improvement, has proposed the following technical solution.

### SUMMARY OF THE INVENTION

The first technical problem to be solved by the present invention is to overcome the deficiencies of the existing technology and to provide an automatic extraction device for perfume decanting. This automatic extraction device has many advantages such as a simple structure, small size, and ease of portability.

To address the aforementioned first technical problem, the present invention adopts the following technical solution:

An automatic extraction device for perfume decanting, comprising: a piston cylinder, a piston, and a piston rod, wherein a front end of the piston cylinder is integrally formed with a nozzle that communicates with an inner chamber of the piston cylinder; the piston mounted on a front end of the piston rod extends into the chamber of the piston cylinder; a liner fixedly provided inside the piston cylinder; wherein the front end of the piston rod passes through the liner and is fixedly connected with the piston; a space between the liner inside the piston cylinder and the nozzle constitutes the compression space of the piston; a compression spring fitted onto the piston rod; the compression spring having front and rear ends acting between the liner and the piston rod; the compression spring exerting a force on the piston rod, causing the piston to have a tendency to move away from the nozzle; wherein an external force acting on the piston rod overcomes the resilience of the compression spring; this acting force pushes the piston rod, driving the piston to compress the compressed space within the cavity; upon releasing the external force, the resilience of the compression spring drives the piston to return to the original position; utilizing the compressed space to generate negative pressure, achieving extraction of perfume from the nozzle.

More preferably, wherein the liner is tubular in shape, inserted from a rear end opening of the piston cylinder, and forms a nested fitting with the piston cylinder.

More preferably, wherein a rear end of the piston rod is fixedly provided with a pressing piece including a pressing end and a guide tube integrally formed in a fixed position with the pressing end; the guide tube is inserted into the liner.

More preferably, further includes a front cover and a rear cover respectively fitted to the front and rear ends of the piston cylinder.

More preferably, wherein the liner is provided with a shaft sleeve that cooperates with the piston rod.

More preferably, wherein the piston rod has a threaded section; a nut is provided at the position of the liner; the front end of the piston rod passes through the liner and the nut to connect with the piston; and by means of the threaded connection between the nut and the threaded section, adjusting the feed of the nut changes the length of the piston rod protruding from the liner, altering the size of the compression space.

More preferably, wherein the connection between the piston rod and the piston is achieved either by a threaded connection or by a snap fit.

More preferably, further includes a connector made of plastic material that fits with the nozzle; the connector comprises a first channel that fits with the nozzle and a second channel for fitting with a perfume bottle spray head; the first channel and the second channel are interconnected.

The second technical problem addressed by the present invention is to provide a connector for perfume decanting.

The second technical problem addressed by the present invention is to provide a connector for perfume decanting, enabling the perfume extraction device to be compatible with perfume bottles of different models and specifications.

To solve the aforementioned second technical problem, the present invention has adopted the following technical solution:

A connector for perfume decanting, comprising: a first channel compatible with a liquid nozzle of a perfume extraction device; a second channel for coupling with a perfume bottle spray head; wherein the first channel and second channel are interconnected through a first hole, and the second channel is designed as a stepped hole.

More preferably, wherein the second channel being provided with at least a first step and a second step for interfacing with different perfume bottle spray heads.

More preferably, wherein one end of the connector being configured with an air groove communicating with the second channel.

More preferably, wherein the inner wall of the first channel inclining to form a funnel shape with an opening that has a chamfered angle.

More preferably, wherein the first channel includes a silicone pad, the center of the silicone pad is formed with a second hole that communicates with the first hole.

More preferably, wherein one end of the silicone pad forming a semi-circular protruding ring, and the bottom of the first channel forming a ring groove for matching and positioning with the protruding ring.

Based on the aforementioned technical solution, the working mechanism of this invention's automatic extraction device is as follows:

Firstly, the design of this invention is simple. It operates on the principle of a syringe, paired with the natural resilience of a compression spring to perform the extraction process. Users only need to press the piston rod, and with the spring's natural resilience, the extraction task is accomplished.

Secondly, this invention introduces a connector, utilizing this connector to form a seal, ensuring there is no leakage during the perfume extraction process.

Lastly, the invention allows users to adjust the volume of perfume extracted. By changing the compression space size, one can alter the capacity of perfume extracted each time, allowing users to adjust as per their requirements.

Compared to existing technologies, the beneficial effects of this invention are:
1. This invention significantly simplifies the operation, making it user-friendly.
2. In the connector of this invention, the second channel adopts a step-hole shape structure, allowing it to connect with various styles of perfume bottles, thereby saving user costs and reducing resource wastage.

### BRIEF DESCRIPTION OF THE DRAWINGS

FIG. 1 is a sectional view of the first embodiment of the automatic extraction device in this invention;

FIG. 2 is an exploded perspective view of the first embodiment of the automatic extraction device in this invention;

FIG. 3 is an exploded perspective view of the first embodiment of the automatic extraction device in this invention, with the front and rear covers removed;

FIG. 4 is a schematic view of the usage state of the first embodiment of the automatic extraction device in this invention;

FIG. 5 is an exploded perspective view of the second embodiment of the automatic extraction device in this invention, with the front and rear covers removed;

FIG. 6 is a sectional view of the second embodiment of the automatic extraction device in this invention;

FIG. 7 is a front view of the first embodiment of the connector in this invention;

FIG. 8 is a sectional view along the A-A direction in FIG. 7;

FIG. 9 is a bottom view of the first embodiment of the connector in this invention;

FIG. 10 is a perspective view of the first embodiment of the connector in this invention;

FIG. 11 is a usage state view one of the first embodiment of the connector in this invention;

FIG. 12 is a usage state view two of the first embodiment of the connector in this invention;

FIG. 13 is a sectional view of the second embodiment of the connector in this invention;

FIG. 14 is a perspective view of the second embodiment of the connector in this invention.

### DETAILED DESCRIPTION OF THE EMBODIMENTS

The invention is further illustrated by specific examples and accompanying drawings.

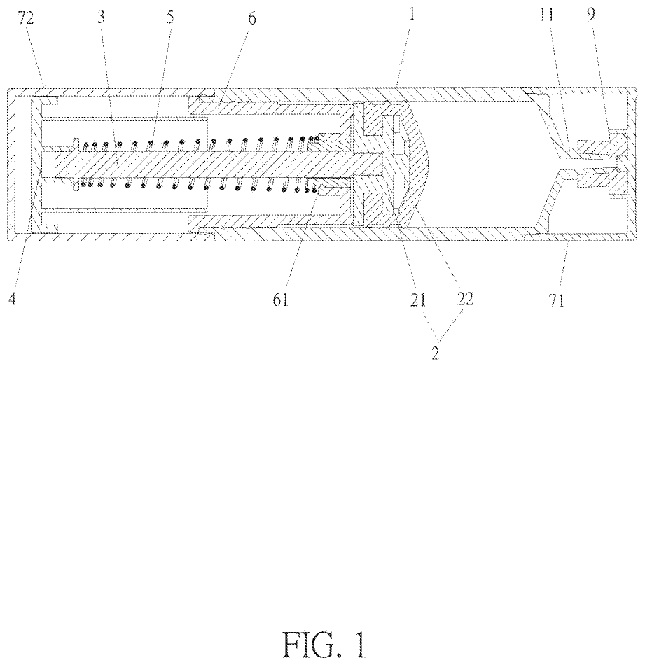

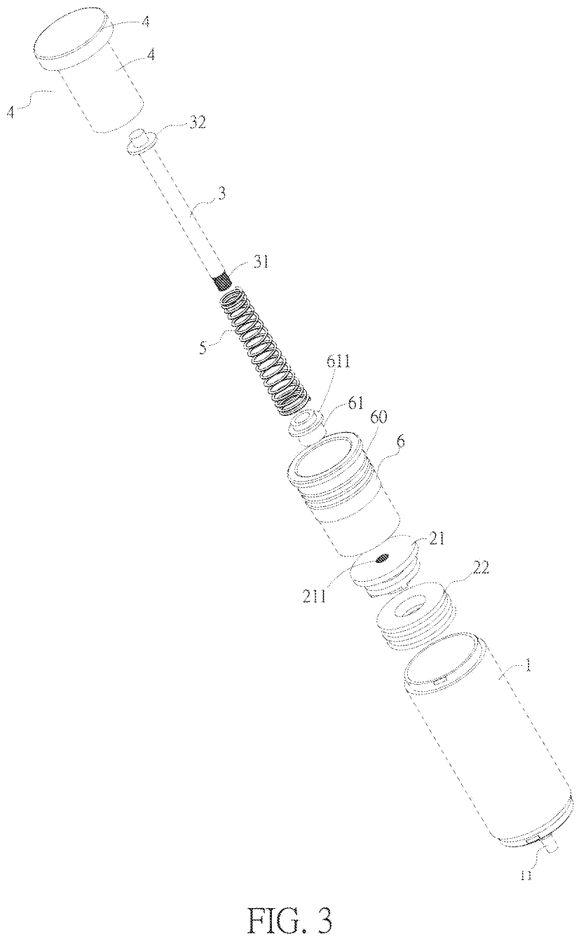

Referring to FIGS. 1 to 4, an embodiment of an automatic extraction device for perfume decanting in the present invention is shown. The device includes a piston cylinder 1, a piston 2, a piston rod 3, a pressing piece 4, a compression spring 5, a liner sleeve 6, as well as a front cover 71 and a rear cover 72.

The piston cylinder 1 has a syringe-like shape overall, with a liquid nozzle 11 formed at the front end connected to the inner cavity, and an opening at the rear end where piston 2 can be inserted.

The piston 2 comprises a support piece 21 and a rubber sleeve 22. The rubber sleeve 22 is snugly fitted over the support piece 21 to form the piston 2. A threaded hole 211 is provided on the support piece 21 for threaded connection with the piston rod 3.

The front end of the piston rod 3 is equipped with connecting threads 31. By connecting these threads 31 with the threaded hole 211, piston 2 connects with piston rod 3 and both are inserted into the cavity 10 of the piston cylinder 1.

The pressing piece 4 is mounted on the rear end of the piston rod 2 and extends outside the piston cylinder 1. Indeed, pressing piece 4 can be integrated with piston rod 2. The pressing piece 4 includes a pressing end 41 and a guide tube 42 integrally fixed with the pressing end 41.

A compression spring 5 is placed on piston rod 1. The two ends of compression spring 5 act directly or indirectly between piston cylinder 1 and piston rod 3. In the current embodiment, a flange 32 is formed at the rear end of piston rod 3. A liner sleeve 6 is fixed inside the piston cylinder 1, and piston rod 2 passes through the liner sleeve 6 and connects with piston 2. The front end of compression spring 5 presses against liner sleeve 6, while the rear end rests against flange 32 (or can rest directly against pressing piece 4). By applying force to pressing piece 4 to overcome the elasticity of compression spring 5, piston rod 3 drives piston 2 to compress the compression space 10 in the cavity. The pushing force generated by compression spring 5 on piston rod 3 drives piston 2 to move away from liquid nozzle 11.

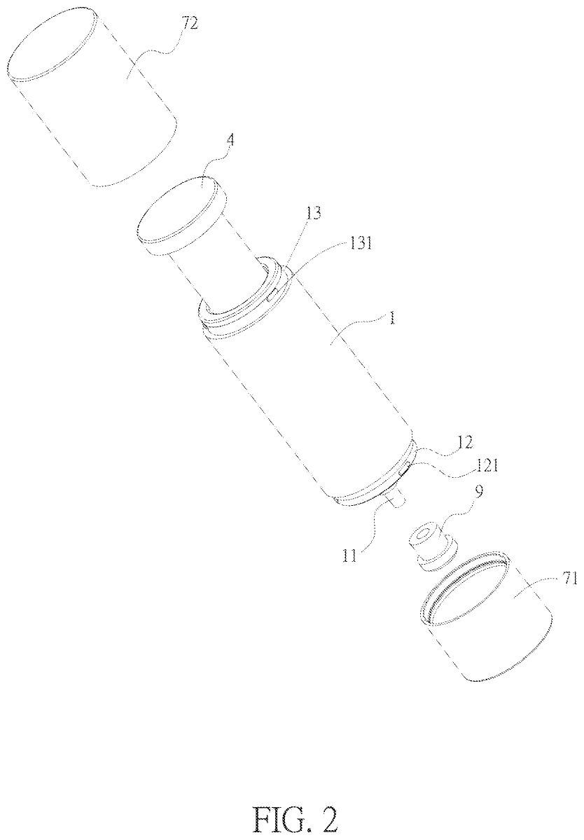

Referring to FIGS. 1 and 2, for aesthetics and protection, the present embodiment also includes front cover 71 and rear cover 72 that respectively match with the front and rear ends of the piston cylinder 1. Steps 12 and 13, which cooperate with front cover 71 and rear cover 72, respectively, are formed at the front and rear sections of the cylinder wall of the piston cylinder. Card protrusions 121 and 131 are formed on the step parts 12 and 13, allowing for a stable match between front cover 71, rear cover 72, and piston cylinder 1.

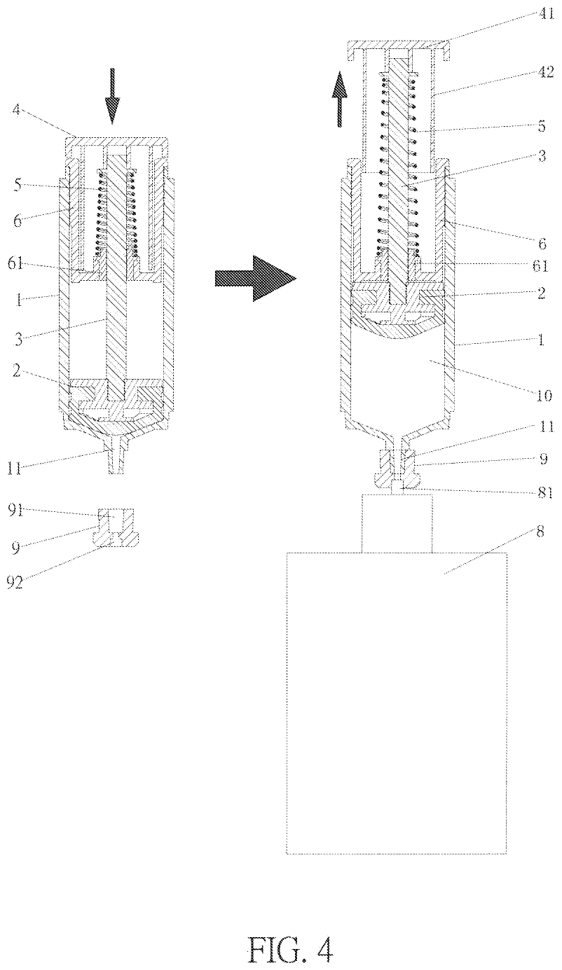

Referring to FIG. 4, during use of the current embodiment, the first channel 91 of the connector 9 fits over the liquid nozzle 11, while the second channel 92 fits over the nozzle 81 of the perfume bottle 8. Then, by applying an external force to the pressing piece 4, the external force overcomes the elastic force of compression spring 5, propelling the piston rod 3 to drive the piston 2 to compress the compression space 10 until the compression space 10 is fully compressed. Upon releasing the external force, the compression spring 5, through its elasticity, exerts a pushing force on the piston rod 3, driving the piston 2 from front to back, gradually releasing the compression space 10 and creating a vacuum or negative pressure, thus drawing perfume from perfume bottle 8 into the compression space 10. After the extraction is complete, the perfume extracted into compression space 10 is injected into a perfume decanting bottle for users to carry with them.

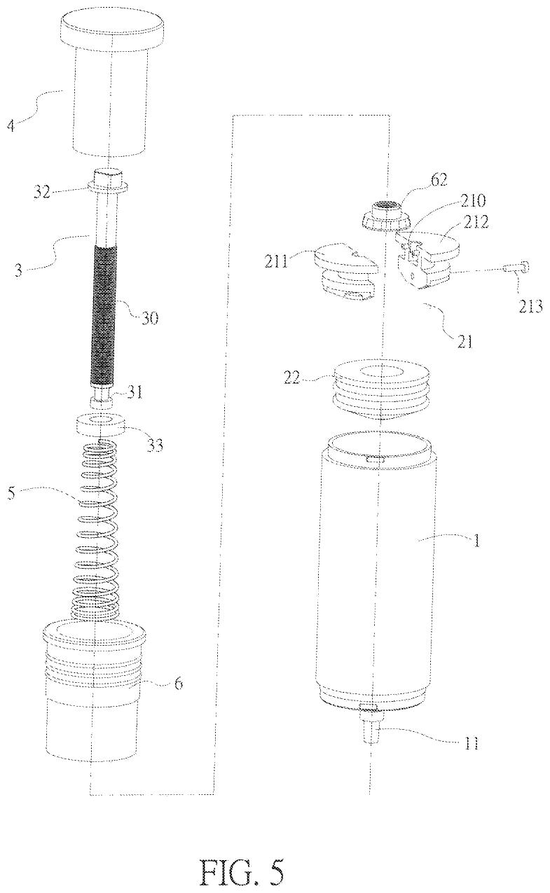

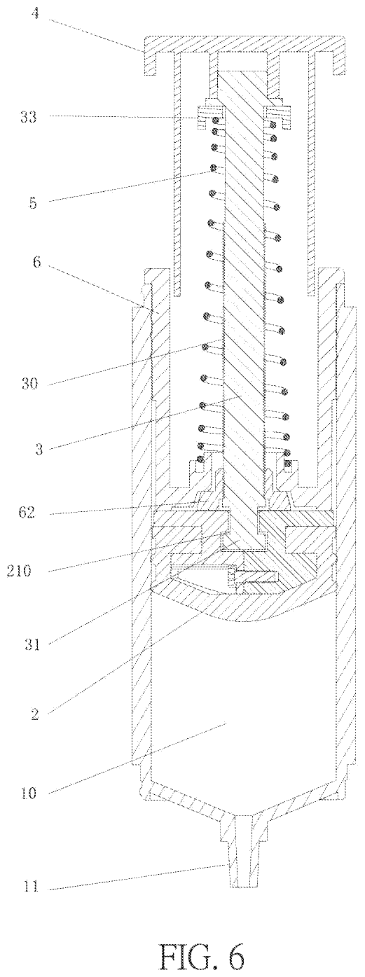

Referring to FIGS. 5 and 6, an embodiment two of the automatic extraction device for perfume decanting according to the invention is depicted. The differences between embodiment two and the previously mentioned embodiment one are:
1. In embodiment two, the piston rod 3 features a threaded section 30. A nut 62 is set at the position of the liner sleeve 6. The front end of the piston rod 3 passes through the liner sleeve 6 and nut 62 to connect with the piston 2. By threading the nut 62 onto the threaded section 30, adjusting the feed of nut 62 changes the length by which piston rod 3 protrudes from the liner sleeve. Consequently, the size of the compression space 10 can be altered, allowing for variations in the amount of perfume extracted each time.
2. In embodiment two, to stabilize compression spring 5, a washer 33 is added because the flange 32 at the rear end of the piston rod 3 cannot stabilize compression spring 5. Once positioned by the flange 32, the internal space of washer 33 effectively limits the rear end of compression spring 5.
3. For ease of installation in embodiment two, the connection between piston rod 3 and piston 2 does not employ the threaded connection from embodiment one. Instead, a snap-fit connection is used. Specifically, the support piece 21 of the piston 2 has a left support piece 211 and a right support piece 212, which are interlocked and then secured with a screw 213. A card slot 210 is formed in the support piece 21. The front end of the piston rod 3 forms a protruding platform 310 that matches with card slot 210. The match between protruding platform 310 and card slot 210 ensures the coordination between piston rod 3 and piston 2.

Other structures of embodiment two are identical to those of embodiment one and are not described here in detail.

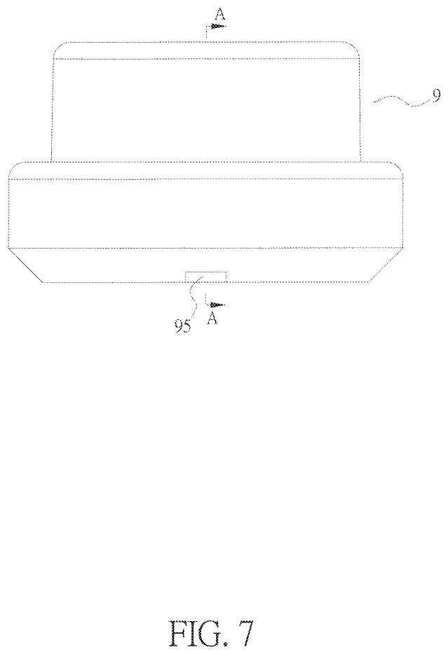

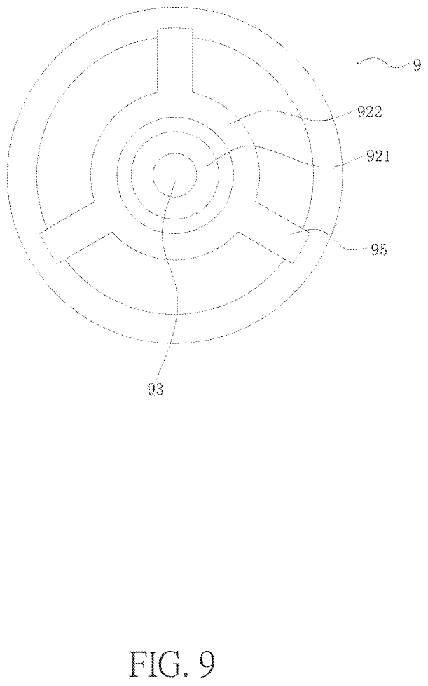

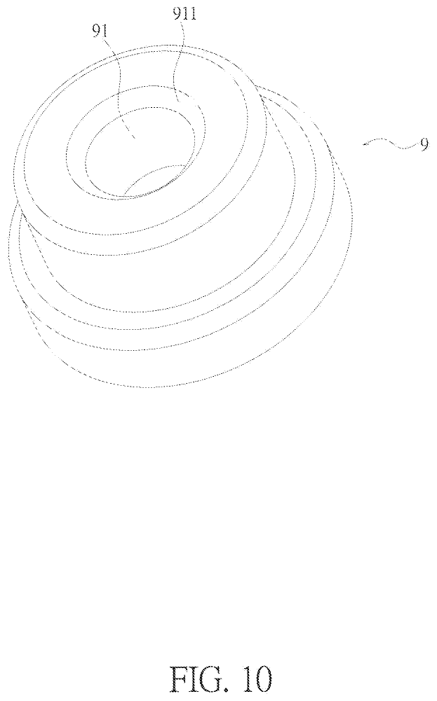

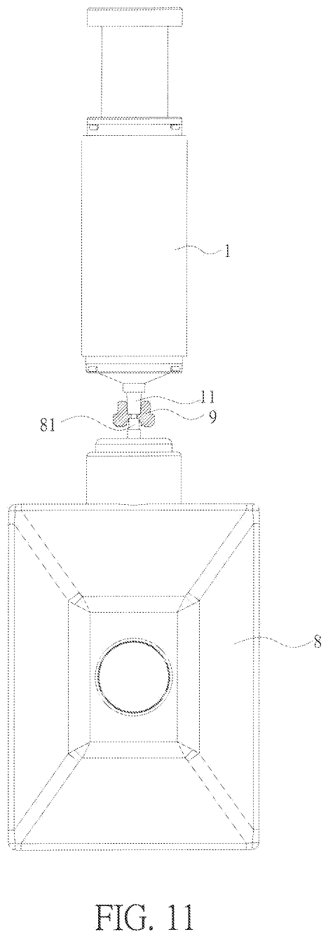

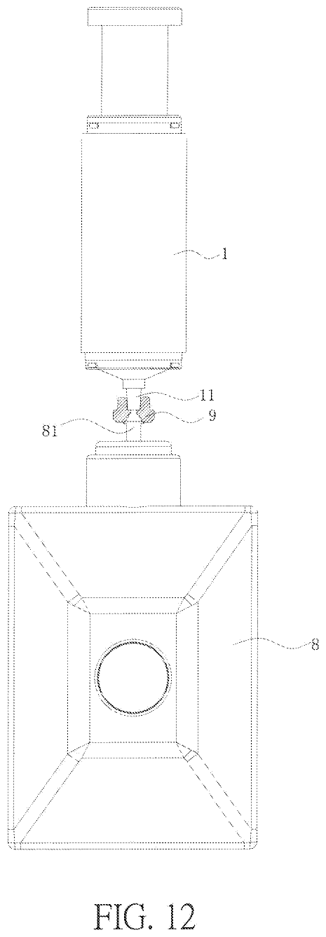

Referring to FIGS. 7 to 12, an embodiment one of the connector in the invention is depicted. The connector 9 comprises: a first channel 91 that matches with the liquid nozzle 11 of the perfume extraction device and a second channel 92 for matching with the nozzle 81 of the perfume bottle. The said first channel 91 and the second channel 92 communicate with each other through the first hole 93, and the second channel 92 is designed as a stepped hole. By placing the second channel 92 and the first channel 91 at the two ends of connector 9 respectively for the perfume bottle 8 and the extraction device, and by inserting the nozzle 81 of the perfume bottle's mouth and the liquid nozzle 11 of the extraction device into the second channel 92 and the first channel 91 respectively, liquid from inside the perfume bottle 8 flows through the first hole 93 into the extraction device. Subsequently, the extraction device injects the perfume into the decanting bottle, completing the perfume replenishment. Adopting a stepped hole shape structure for the second channel 92 allows the second channel 92 to connect with various styles of perfume bottles 8, facilitating shared use of the decanting bottle, saving user costs, and reducing resource wastage. The mentioned extraction device refers to the previously described automatic extraction device.

In the embodiment one of the connector in the invention, the material of connector 9 is silicone. Making use of the elasticity of the silicone material ensures that when the perfume bottle 8 and the extraction device interface with the second channel 92 and the first channel 91 of connector 9, a tight and sealed connection is achieved.

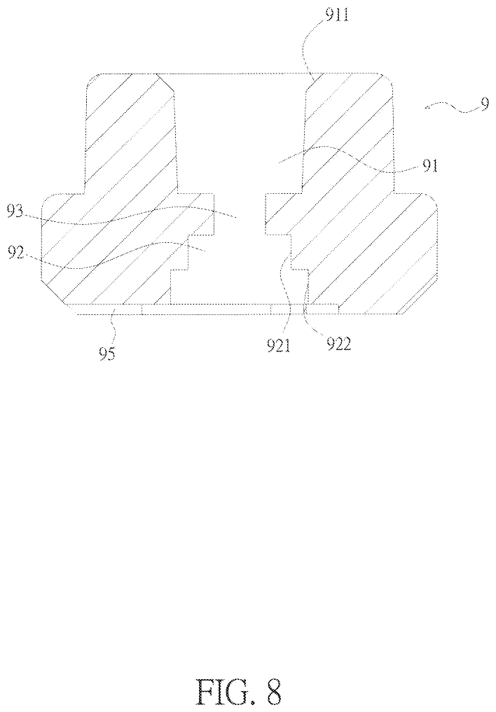

Referring to FIG. 8, within the second channel 92, at least a first step 921 and a second step 922 are established to interface with the nozzle 81 of different perfume bottles. The first step 921 and the second step 922 can correspond to the nozzles 81 of different models of perfume bottles 8. Of course, depending on the requirements, the number of steps can be increased to match more types of perfume bottles, or, alternatively, only one step can be set to fit a single type of perfume bottle.

One end of the connector 9 features an air groove 95 that communicates with the second channel 92. The air groove 95 ensures airflow and maintains air pressure balance. To facilitate matching with the liquid nozzle 11, the inner wall of the first channel 91 tapers in a funnel shape, and the opening is formed with a backward angle 911.

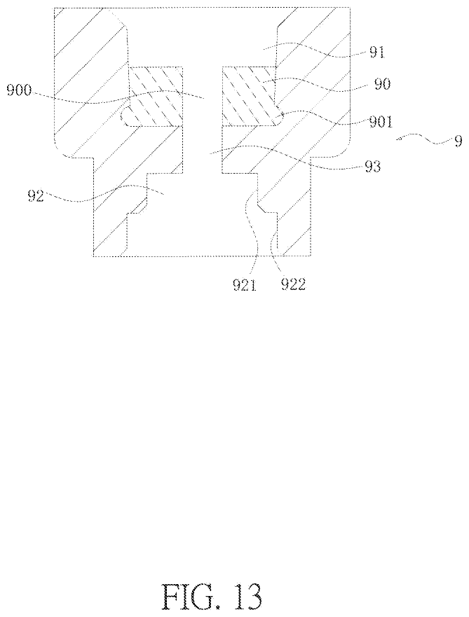

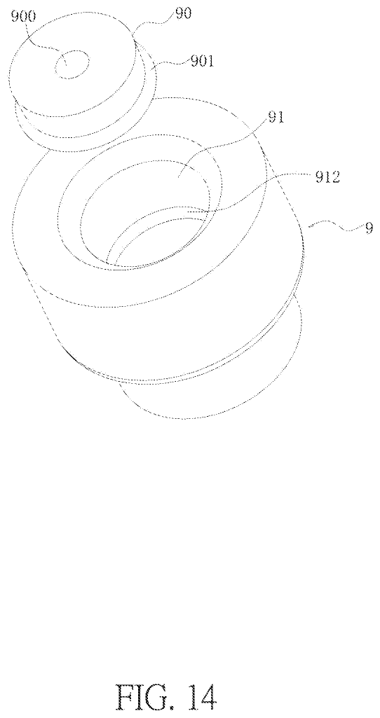

As shown in FIGS. 13 and 14, an embodiment two of the connector in the invention is presented. In the second embodiment, the connector is made of PP material. Leveraging the properties of PP, the inner walls of the second channel 92 and the first channel 91 are smooth, facilitating the connection between the nozzle 81 of the perfume bottle 8 and the second channel 92, as well as the interface of the liquid filling device's nozzle 11 with the first channel 91.

Within the first channel 91 of the second embodiment, a silicone pad 90 is placed. In the center of the silicone pad 90, a second hole 900 is formed, communicating with the first hole 93. By adding the silicone pad 90 inside the first channel 91, the tightness between the liquid nozzle 11 of the extraction device and the first channel 91 is enhanced. This design improves the sealing when the liquid nozzle 11 interfaces with the first channel 91, preventing gaps from forming due to prolonged plugging and unplugging, which could compromise the sealing.

One end of the silicone pad 90 is formed with a semi-circular protruding ring 901, while the bottom of the first channel 91 is formed with an annular groove 912 to match and position the protruding ring 901. The coordination between the protruding ring 901 and the annular groove 912 ensures a stable connection between the silicone pad 90 and the first channel 91.

Certainly, the above descriptions are merely specific embodiments of the invention and are not intended to limit the scope of the invention. Any equivalent changes or modifications made based on the structures, features, and principles described in the patent application scope of the invention should fall within the patent application range of the invention.

I claim:

1. An automatic extraction device for perfume decanting, comprising:
a piston cylinder (1), a piston (2), and a piston rod (3),
wherein a front end of the piston cylinder (1) is integrally formed with a nozzle (11) that communicates with an inner chamber of the piston cylinder (1); the piston (2) mounted on a front end of the piston rod (3) extends into the chamber of the piston cylinder (1);
a liner (6) fixedly provided inside the piston cylinder (1);
wherein the front end of the piston rod (3) passes through the liner (6) and is fixedly connected with the piston (2); a space between the liner (6) inside the piston cylinder (1) and the nozzle (11) constitutes the compression space (10) of the piston (2);
a compression spring (5) fitted onto the piston rod (1); the compression spring (5) having front and rear ends acting between the liner (6) and the piston rod (3); the compression spring (5) exerting a force on the piston rod (3), causing the piston (2) to have a tendency to move away from the nozzle (11);
wherein an external force acting on the piston rod (3) overcomes the resilience of the compression spring (5); this acting force pushes the piston rod (3), driving the piston (2) to compress the compressed space (10) within the cavity; upon releasing the external force, the resilience of the compression spring (5) drives the piston (2) to return to the original position; utilizing the compressed space (10) to generate negative pressure, achieving extraction of perfume from the nozzle (11).

2. The automatic extraction device for perfume decanting as claimed in claim 1, wherein the liner (6) is tubular in shape, inserted from a rear end opening of the piston cylinder (1), and forms a nested fitting with the piston cylinder (1).

3. The automatic extraction device for perfume decanting as claimed in claim 1, wherein a rear end of the piston rod (3) is fixedly provided with a pressing piece (4) including a pressing end (41) and a guide tube (42) integrally formed in a fixed position with the pressing end (41); the guide tube (42) is inserted into the liner (6).

4. The automatic extraction device for perfume decanting as claimed in claim 1, further includes a front cover (71) and a rear cover (72) respectively fitted to the front and rear ends of the piston cylinder (1).

5. The automatic extraction device for perfume decanting as claimed in claim 1, wherein the liner (6) is provided with a shaft sleeve (61) that cooperates with the piston rod (3).

6. The automatic extraction device for perfume decanting as claimed in claim 1, wherein the piston rod (3) has a threaded section (30); a nut (62) is provided at the position of the liner (6); the front end of the piston rod (3) passes through the liner (6) and the nut (62) to connect with the piston (2);
and by means of the threaded connection between the nut (62) and the threaded section (30), adjusting the feed of the nut (62) changes the length of the piston rod (3) protruding from the liner, altering the size of the compression space (10).

7. The automatic extraction device for perfume decanting as claimed in claim 1, wherein the connection between the piston rod (3) and the piston (2) is achieved either by a threaded connection or by a snap fit.

8. The automatic extraction device for perfume decanting as claimed in claim 1, further includes a connector (9) made of plastic material that fits with the nozzle (11); the connector (9) comprises a first channel (91) that fits with the nozzle (11) and a second channel (92) for fitting with a perfume bottle spray head; the first channel (91) and the second channel (92) are interconnected.

9. A connector for perfume decanting, comprising:
a first channel (91) compatible with a liquid nozzle (11) of a perfume extraction device;
a second channel (92) for coupling with a perfume bottle spray head (81);
wherein the first channel (91) and second channel (92) are interconnected through a first hole (93), and the second channel (92) is designed as a stepped hole.

10. The connector for perfume decanting as claimed in claim 9, wherein the second channel (92) being provided with at least a first step (921) and a second step (922) for interfacing with different perfume bottle spray heads (81).

11. The connector for perfume decanting as claimed in claim 9, wherein one end of the connector (9) being configured with an air groove (95) communicating with the second channel (92).

12. The connector for perfume decanting as claimed in claim 9, wherein the inner wall of the first channel (91) inclining to form a funnel shape with an opening that has a chamfered angle (911).

13. The connector for perfume decanting as claimed in claim 9, wherein the first channel (91) includes a silicone pad (90), the center of the silicone pad (90) is formed with a second hole (900) that communicates with the first hole (93).

14. The connector for perfume decanting as claimed in claim 13, wherein one end of the silicone pad (90) forming a semi-circular protruding ring (901), and the bottom of the first channel (91) forming a ring groove (912) for matching and positioning with the protruding ring (901).
